(19) United States
(12) Patent Application Publication
(10) Pub. No.: US 2005/0163968 A1
(43) Pub. Date: Jul. 28, 2005

(54) Microfiller-reinforced polymer film

(76) Inventor: Gregory M. Hanket, Newark, DE (US)

Correspondence Address: Arnold S. Weintraub;The Weintraub Group, P.L.C., Suite 240, 32000 Northwestern Highway, Farmington Hills, MI, 48334, US

(21) Appl. No.: 11/039,034

(22) Filed: Jan. 20, 2005

Related U.S. Application Data
(60) Provisional application No. 60/537,747, filed on Jan. 20, 2004.

(51) Int. Cl. B32B 25/02

(52) U.S. Cl. 428/143; 428/295.1; 428/295.4; 428/149

(57) ABSTRACT

A thin polymer film having improved properties of reduced coefficient of thermal expansion (CTE), reduced shrinkage, increased modulus, and greater resistance to chemical attack is produced by a method wherein a plastic material is filled with a microfiller. Optimally, the present invention provides a micro-filled polyimide film.

### CROSS-REFERENCE TO RELATED APPLICATIONS

This application claims priority to U.S. Provisional Patent Application No. 60/537,747, filed on Jan. 20, 2004, the disclosure of which is incorporated herein by reference in its entirety.

### BACKGROUND

1. Field of the Invention

The present invention relates to microfiller-reinforced polymer films for use, among other applications, as substrates for thin film deposition as in the fabrication of flexible flat-panel displays and solar cells, as laminates in flex circuits, and in other applications where improved mechanical properties over traditional polymer films are desired.

2. Prior Art

High performance polymer films, utilizing classes of polymers such as polyesters, polyimides, polyetherimides, and polyetheretherketones are currently in widespread use. These films are characterized by their relatively high elastic moduli, low coefficients of thermal expansion, and tolerance to high temperatures.

Among other applications, high performance polymer films are used as electrically insulating laminates for the fabrication of “flex-circuits.” These, generally, comprise patterned copper (either foil or deposited) laminated between polymer films. Polymer films have also been used as substrates for numerous thin film deposition processes, including the manufacture of thin film solar cells, the manufacture of which requires the substrate to survive temperatures exceeding 400° C.

Another highly desirable application is as a substrate for flexible flat panel displays, whose manufacture may also require process temperatures approaching 400° C. However, these polymer films are not entirely suitable for some types of displays due to their coloration, coefficient of thermal expansion, inadequate melting or glass-transition temperatures, inadequate dimensional stability, etc.

Further, the coefficient of thermal expansion of polymer films is typically greater than some of the thin films that may be deposited on them, e.g. silicon films for thin film transistor arrays and sputtered molybdenum films for the manufacture of solar cells. As an example of the thermal expansion mismatch in the deposition of some metallic thin films onto polymer films, the lowest cited coefficient of thermal expansion (CTE) for a polyimide film is 12 ppm/° C., while silicon has a coefficient of thermal expansion of only 2.5 ppm/° C., and molybdenum of about 6 ppm/° C. When taken to a sufficiently high temperature, the thermal expansion mismatch between the metal and polymer film may cause fracturing of the metal film, causing visible texturing of the film and a discontinuity in the lateral electrical conduction.

Furthermore, the properties of polymer films may be dependent on the thermal history of the film. Properties such as coefficient of thermal expansion and modulus are, therefore, dependent not only on the controllability of the manufacturing process, but also any history of subsequent high temperature processing.

The present invention seeks to improve the properties of existing polymer films by providing a microfiller-reinforced polymer film, and corresponding fabrication process, that has a reduced coefficient of thermal expansion, increased elastic modulus, improved dimensional stability, and reduced variability of properties due to either process variations or thermal history. Additionally, the microfiller-reinforced film may in some cases be more cost effective than an unfilled film, owing to 1) the lower cost of the microfiller compared to polymer film precursors and 2) the increased stiffness of the film due to the microfiller and corresponding reduction in required film thickness and weight to meet given stiffness or strength requirements.

### DESCRIPTION OF THE PREFERRED EMBODIMENTS

The present invention provides a microfiller-reinforced polymer film. As used herein, microfiller denotes a “high-aspect-ratio” filler with a minor dimension less than 20 μm as well as denoting a geometry wherein the major dimension of the filler is at least three times greater than the minor dimension. Examples of such high-aspect-ratio microfillers include for example 1) a microfiber with a diameter less than 20 μm and a length greater than 3 times the diameter; 2) a microflake with a thickness less than 20 μm and width and length greater than 3 times the thickness; or 3) a microribbon with a thickness less than 20 μm and a length greater than 3 times the thickness. It is this “high-aspect-ratio” microfiller dispersed in a polymer matrix in the form of a film that defines the present invention. It should be noted that as used herein, and as understood in the art, that “film” signifies a polymer film having a thickness less than 0.010 inch. The ratio of the composite film thickness to the minor dimension of the filler is at least 2 to 1 and usually ranges from about 20 to 1 to about 50 to 1.

The presence of the high-aspect-ratio microfiller in the film serves to increase the modulus and decrease the CTE, and otherwise stabilize the physical dimensions of the film, for example, by reducing certain effects such as irreversible film shrinkage normally occurring at high temperatures.

The high aspect ratio of the microfiller is critical to the practice of the present invention. Instead of simply “averaging” the polymer and microfiller properties, the high-aspect-ratio microfiller induces a shear strain into the polymer surrounding the microfiller, thereby weighting the film properties disproportionately to those of the microfiller. By suitably choosing the polymer and microfiller compositions and ratios, it is theoretically possible to match the film CTE to some metals such as copper and aluminum. This renders the present microfiller-reinforced film desirable as a substrate material.

Moreover, in another aspect hereof it is noteworthy that by suitably choosing polymer and microfiller compositions with similar indices of refraction, the film transparency may be maximized. Conversely, polymer and microfiller compositions with disparate indices of refraction will cause increased light diffusivity and reflection within the film.

In preparing the film in accordance herewith, the microfiller is present in an amount ranging from about 1% to about 99% of the volume of the film. The amount of microfiller is selected depending on the microfiller properties, polymer properties, and desired properties of the resultant film. Preferably, the microfiller is present in an amount ranging from about 15% to about 20% of the film volume. Again, though, the microfiller quantity may be varied to yield the desired properties for the resultant film. It should be noted that the manufacturing process can also be used to control film properties. For example, by varying the quench rate of some extruded thermoplastics it is possible to influence index of refraction and haze value. Specifically, the optical properties of a polyethylene terephthalate (PET) film are known to be controllable to some degree using a quench roller film casting process.

The microfiller is incorporated into the film by dispersing it in the polymer melt, resin, or other precursor before extruding, casting, or otherwise forming the film with methods currently known in the art. Alternately, the film may be formed by impregnating a nonwoven microfiber mat with the polymer melt, resin, or liquid precursor.

In use the microfiller may be randomly dispersed and oriented or may be directionally oriented, as required. The generally occurring alignment of fibers due to flow is well known, and contributes to some degree of anisotropy of the resultant film. The maximization of anisotropy may be desirable in the manufacture of high modulus tapes, for example, or for achieving anisotropy of electrical properties if a conductive microfiber is utilized. Anisotropy is generally not desirable in the manufacture of films intended for use as substrates. In this case, microflakes are a preferred filler. Alternately, tentering or stentering (stretching the film in the transverse direction) of a microfiber-filled film may be used to decrease film anisotropy.

Since the presence of the microfiller near the film surface may negatively influence the smoothness of the film surface, the film may be calendared at an appropriate point in the manufacturing process in order to improve the surface finish.

In practicing the present invention, the useful microfillers are, for example, glass microfibers, metal-coated glass microfibers, carbon microfibers, ceramic microfibers, metal microfibers or microwires, microfibers of a polymer or polymers dissimilar in composition to the film matrix, natural or artificially produced silk microfibers, mineral microfibers such as asbestos, naturally occurring plant or animal microfibers, glass microflakes or microribbons, metal-coated glass microflakes or microribbons, carbon microflakes or microribbons, ceramic microflakes or microribbons, metal microflakes or microribbons, microflakes or microribbons of a polymer or polymers dissimilar in composition to the film matrix, mineral microflakes or microribbons such as mica, naturally occurring plant or animal microflakes or microribbons, blends of any or all of the aforementioned microfillers, and the like. Preferably, for substrate applications where good optical transparency is desired, the microfiller comprises a glass microflake, such as that sold commercially under the name MicroGlas® REF-160 by NGF Canada.

For applications, such as high modulus tapes, where mechanical properties are of utmost importance and optical properties and film isotropy may be neglected, the microfiller is, preferably, a carbon microfiber. It should be noted, though, that the preferred microfiller and its quantity are usually selected in response to the desired film properties such as film transparency, electrical conductivity, and coefficient of thermal expansion.

The presence of “high-aspect-ratio” microfillers does not preclude the simultaneous presence of other functional fillers already known in the art. These functional fillers may be used to modify the chemical or optical properties of the film. An illustrative example is the addition of TiO2 particles to reduce polymer degradation due to ultraviolet light.

Among the useful polymers for use herein are the previously mentioned polyimides, polyetherimides, polyetheretherketones, and polyesters, such as polyethylene terephthalate and polyethylene naphthalate, as well as liquid crystal polymers, polyamides, polyethersulfones, phenolics, silicones and silicone rubbers, and the like.

The present invention has particular utility in the manufacture of a transparent substrate for deposition of a silicon thin film transistor (TFT) array for manufacture of a flexible flat panel display. In manufacturing such a substrate, generally, a 40% by weight E-glass microflake is blended into a PET melt prior to forming the film. The E-glass microflake is used because of the resultant low anisotropy, reduced refractive scattering owing to the filler geometry, and its close refractive index match to PET (1.56 to approximately 1.6), thereby retaining as much film transparency as possible. Processing of the silicon film is known such as disclosed in U.S. Pat. No. 6,642,085, the disclosure of which is hereby incorporated by reference. During processing of the silicon film, the film is heated above its glass transition temperature, above which the properties of unreinforced polyester become highly variable and ill defined. Reinforcement of the film by the glass microflake moderates the variability of film properties, such as CTE and modulus, above this temperature.

In another embodiment hereof there is provided a microfiber-filled polyimide film prepared by solvent casting for use in high temperature, high modulus applications. Polyimide films are synthesized by the reaction of a dianhydride, such as pyromellitic dianhydride, and a diamine, such as 4-4′ oxydianiline (ODA). These substances are typically powders under ambient conditions. In forming a film therefrom they are dissolved in a 1:1 mole ratio in an appropriate solvent, such as n-methylpyrrolidone (NMP) where they react to form poly(amic acid) chains. The microfiller, such as an 0.5 μm diameter borosilicate microfiber, is then blended into this solution to a weight ratio of from about 1:6 to about 1:3 to the poly(amic acid). The solvent weight fraction in the poly(amic acid)/microfiber/solvent composition may be as high as 95% before extrusion. This poly(amic acid)/solvent/microfiller composition is extruded onto a continuous belt, then heated to a temperature of about 100° C. to drive off the solvent resulting in a solid film. Due to the incorporation of the microfiller, the film may be expected to exhibit texturing on the upper surface (that surface opposite to that in contact with the belt). Smoothing of the upper surface can be accomplished by the extrusion of a second non-filled poly(amic acid)/solvent film on top of the original microfiller/poly(amic acid)/solvent film followed by a second solvent bake-off. Alternately, smoothing may be accomplished by using calender rollers on the poly(amic acid) film to smooth the film after disengagement from the belt. The resultant film is then lifted off the belt, supported on either side with a minimum amount of stress, carried through a furnace, and thermally imidized to convert the poly(amic acid) chains to polyimide via a dehydration reaction. Imidization can be accomplished by a variety of cure cycles, with higher cure temperatures requiring shorter cure times. Typical curing is conducted by ramping the temperature from about 100° C. to about 300° C. over a period of about three hours, or by an approximately half-hour cure at 400° C.

Similarly, as noted above, microfiber mats may be used herein. Where used, they are associated with the film by impregnation with a thermoplastic melt, resin, or precursor solution. In the case of a polyimide, for example, the mat is impregnated with the poly(amic acid)/solvent composition, then heated to drive off the solvent, resulting in a mat impregnated with poly(amic acid). The resultant microfiber/poly(amic acid) mat may then be imidized as discussed hereinabove.

Further and according to this invention a clear plastic film for use in electronics manufacturing that has the ability to stand up to and tolerate both the temperatures and resistance to certain aggressive chemicals used in electronics can be manufactured in accordance with the principles hereof. Since polyimide will tolerate the temperature and chemicals, but has a yellowish color, it has to be used in very thin layers to avoid tinting the display, but not so thin that it is self supporting.

To this end, a thin polyimide film may be fabricated on aluminum foil, and the so-fabricated substrate is then bonded to a plastic film e.g. glass microflake filled PETG with an epoxy. The structure so-obtained is a PETG/epoxy/polyamide/aluminum layered device. The aluminum film is then etched away to leave a polyimide surface film. The remaining structure is PETG/epoxy/polyimide. The product is usable as a lift-off in the fabrication of flexible displays, where entire transistor arrays, color filter arrays, etc. are deposited on a sacrificial substrate, bonded, and then etched. The polyimide provides good encapsulation so that the sensitive display elements are protected from the etching agent.

Following is an illustrative non-limiting example of the present invention where all parts are by weight absent contrary indications.

### EXAMPLE

This example illustrates the preparation of a microfiber-filled polyimide film.

One part of a glass microfiber, sold commercially by West System, under the name #403 Microfibers is blended at room temperature into a 4 part solution poly(amic acid) solution. The poly(amic acid) solution comprises 13 parts poly(pyromellitic dianhydride-co-4,4′-oxydianiline), 70 parts n-methylpyrrolidone, and 17 parts aromatic hydrocarbon, and is sold commercially under the product number 57,579 by Aldrich Chemical.

The resultant slurry is blotted onto a glass slide and baked for 15 minutes at 75° C. in ambient atmosphere to drive off the n-methylpyrrolidone/aromatic hydrocarbon solvent. The resultant self-supporting microfiber/poly(amic acid) film is peeled from the glass slide. The upper side of the film exhibits a texturing due to the presence of the glass microfiber in the film.

1. A composite film selected from the group consisting of (a) microfibrous filler dispersed in a polymer matrix or (b) a polymer-impregnated nonwoven microfiber mat.

2. The film of claim 1, wherein the microfibrous filler is an inorganic microfiber.

3. The film of claim 2, wherein the filler is selected from the group consisting of glass, ceramic and carbon.

4. The film of claim 1, wherein the polymer matrix is a polyimide.

5. The film of claim 1, wherein the microfibrous filler is randomly dispersed and oriented.

6. The film of claim 1, wherein the microfibrous filler is directionally oriented.

7. A method for producing a thin polymide film comprising; (a) bonding a polyimide film on a layer of aluminum foil, (b) bonding the product of (a) with an epoxy the fabrication to a substrate film of a microfibrous filler dispersed in either a polymer matrix, polymer-impregnated nonwoven microfiber mat, and (c) etching by removing the aluminum foil to leave a polyimide surface film.

8. The method of claim 7, wherein the substrate film is glass microflake filled PETG.

9. A thin polymer film produced by the method of claim 7.
